(19) United States
(12) Patent Application Publication
(10) Pub. No.: US 2001/0054955 A1
(43) Pub. Date: Dec. 27, 2001

(54) Monitoring device for a control unit, preferably for controlling signal lights of motor vehicles

(75) Inventor: Werner Diez, Wolfschlugen (DE)

Correspondence Address: Gudrun E. Huckett, Ph.D., P.O. Box 3187, Albuquerque, NM, 87190-3187, US

(73) Assignee: Reitter & Schefenacker GmbH & Co. KG, Esslingen (DE)

(21) Appl. No.: 09/888,265

(22) Filed: Jun. 21, 2001

(30) Foreign Application Priority Data
Jun. 23, 2000 (DE) 20011115.9

(51) Int. Cl. B60Q 1/00

(52) U.S. Cl. 340/435; 340/479

(57) ABSTRACT

A monitoring device for a control unit for controlling a signal light of a motor vehicle, wherein the signal light comprises one or more tail lights and one or more brake lights and wherein each one of the one or more tail lights and the one or more brake lights has at least one lighting element and at least one signal input connected to the lighting element, respectively, has at least one electronic switch configured to open an emergency path to at least one of the one or more tail lights and the one or more brake lights when the control unit malfunctions.

### BACKGROUND OF THE INVENTION

1. Field of the Invention

The invention relates to a monitoring device for a control unit, preferably employed for controlling signal lights of vehicles, in particular, of motor vehicles wherein the signal light has at least one tail light and at least one brake light which are provided respectively with at least one lighting element that is connected to a signal input, respectively.

2. Description of the Related Art

Signal lights in the form of tail light assemblies of motor vehicles are known which comprise a tail light, a brake light, a turn signal light, and a rear fog light. When within the control circuit to the signal light an error occurs and, accordingly, one or more of the functional lights fail, a considerable safety risk results when driving in traffic, in particular, because the driver of the motor vehicle will not recognize the malfunction of the lights.

### SUMMARY OF THE INVENTION

It is an object of the present invention to configure the monitoring device of the aforementioned kind such that a disturbance in the circuit of the signal light does not cause a safety risk.

In accordance with the present invention, this is achieved in that the monitoring device has at least one electronic switch with which an emergency path to the tail light and/or to the brake light can be activated when the control unit experiences a malfunction or disturbance.

When in the monitoring device according to the invention a disturbance occurs within the control circuit or current circuit to the signal light, the emergency path to the tail light and/or to the brake light is opened by means of the electronic switch so that via this emergency path the tail light and/or the brake light is supplied with the required current. Activating the emergency path is carried out automatically so that the signal light operates properly independent of whether the driver of the vehicle recognizes the disturbance.

### BRIEF DESCRIPTION OF THE DRAWING

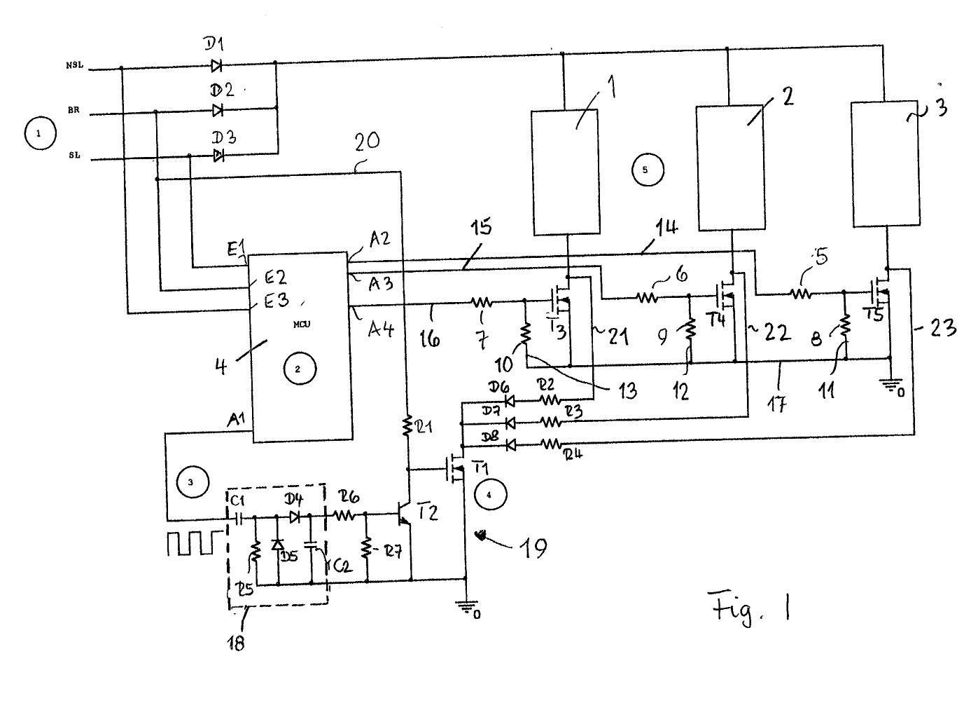

In the drawing the only FIG. 1 shows a circuit diagram of the monitoring device according to the invention for monitoring a control unit.

### DESCRIPTION OF THE PREFERRED EMBODIMENTS

The monitoring device according to the invention illustrated in FIG. 1 is configured to monitor a control unit which controls the tail light assembly of a motor vehicle in the shown embodiment. However, the device can also be used for monitoring any other type of control unit.

In the illustrated embodiment, the tail light assembly has three luminous fields 1 to 3, of which the luminous field 1 is a rear fog light, the luminous field 2 is a brake light, and the luminous field 3 is a tail light. The luminous fields 1 to 3 each comprise at least one lighting element which can be an incandescent light bulb, respectively. Advantageously, all three luminous fields 1 to 3 are comprised of LEDs. The monitoring device has signal inputs NSL, BR, and SL via which the respective luminous fields 1 to 3 receive the required signals. Each signal input has arranged downstream thereof a diode D1 to D3. The diodes D1 to D3 are arranged parallel to one another. In the current path from the signal inputs NSL, BR, and SL to the luminous fields 1 to 3 a control unit 4 is arranged which is formed by a microcontroller with a control program. The control unit 4 has input terminals E1 to E3. The signal input SL for the tail light is connected to the input terminal E1, the signal input BR for the brake light is connected to the input terminal E2, and the signal input NSL for the fog light is connected to the input terminal E3. The control unit 4 is moreover provided with output terminals A2 to A4 to which the luminous fields 1 to 3 are connected via electronic elements such as semiconductor switches T3 to T5 in a way to be described in the following. A resistor 5 is arranged within the current path 14 between the signal output A2 and the corresponding semiconductor switch T5, a resistor 6 is arranged in the current path 15 between the signal output A3 and the corresponding semiconductor switch T4, and a resistor 7 is arranged between the signal output A4 and the corresponding semiconductor switch T3 in the current path 16.

The control unit 4 is provided with a further signal output A1 via which the switching signal for switching off the emergency path 9, to be described in the following, is provided. A resistor 8 to 10 is serially connected to the resistor 5 to 7, respectively. The resistors 8 to 10, in turn, are arranged parallel to one another. The resistors 8 to 10 are arranged in a current path 11 to 13, respectively, which connect the current paths 14 to 16 between the output terminals A2 to A4 and the corresponding semiconductor switches T3 to T5 with a current path 17.

A rectifier 18 is connected to the signal output A1 of the control unit 4 and is positioned within the emergency path 19 of the monitoring device. By means of this emergency path 19, it is ensured that the proper functioning of the tail light SL and/or of the brake light BR is ensured when a disturbance or failure within the control unit 4 and/or in the control circuit from the signal inputs NSL, BR, SL to the luminous fields 1 to 3 occurs. The rectifier 18 generates, based on a control signal in the form of an alternating current signal present at the signal output A1, a direct current which opens an electronic element in the form of a transistor T2 in the emergency path 19 so that current is conducted through a resistor R1 connected serially to the transistor T2. The rectifier 18 has a capacitor C1, a diode D4, and a resistor R6 which are connected in series to one another and to the transistor T2. Moreover, the rectifier 18 is provided with a resistor R5, a diode D5, a capacitor C2, and a resistor R7 which are connected parallel to one another and to the transistor T2.

An electronic switch (semiconductor switch) T1 is connected downstream of the transistor T2 and is also positioned within the emergency path 19. It is also provided with the diones D6 to D8 as well as with the resistors R2 to R4 serially connected to the diodes D6 to D8. The diodes D6 to D8, which block in the direction toward the control unit 4, as well as the resistors R2 to R4, connected serially to the diodes D6 to D8, are correlated with the luminous fields 1 to 3.

When the control unit 4 for the tail light assembly with the luminous fields 1 to 3 operates properly, the control unit 4 receives upon actuation of the brake a corresponding brake signal which is supplied via the brake input BR to the input terminal E2 of the control unit 4. The control unit 4 processes this brake signal by means of its program. As long as the control unit operates properly, it generates alternating current at the signal output A1. Based on this alternating current signal, a direct current is generated by means of the diode D4, D5 and the capacitors C2, C1 which opens the transistor T2 so that current is conducted through the resistor R1 arranged serially to the transistor T2. In this connection, the voltage at the collector of the transistor T2 against ground drops to zero. This has the result that the semiconductor switch T1 downstream of the transistor T2 is blocked. Simultaneously with the generation of the alternating current signal at the signal output A1, output signals are generated at the signal outputs A2 to A4 of the control unit 4 and are supplied via the current paths 14 to 16 to the semiconductor switches T3 to T5. They control the luminous fields 1 to 3. The brightness control of the luminous fields 1 to 3 is realized by a pulse-width modulated signal.

In the case that the control unit and/or the control circuit no longer operates properly, for example, fails, the emergency path 19 is opened via the semiconductor switch T1. When, for example, the brake pedal is actuated upon failed control, a potential is present at the signal input BR. Via a current path 20, in which the resistor R1 is positioned and which is guided from the signal input BR to the semiconductor switch T1, the semiconductor switch T1 receives via the resistor R1 at its gate a positive potential and is thus conductive. The transistor T2 and the semiconductor switches T3 to T5 at this point in time are blocked because of the failure or the disturbance of the control unit 4 and/or of the control circuit. Via the open semiconductor switch T1 the luminous fields 1 to 3 are grounded via the diodes D6 to D8 and the resistors R2 to R4 to the reference potential zero. The luminous fields 1 to 3 are supplied with the required potential or the required current and are illuminated. The brightness of the luminous fields 1 to 3 is determined by the size of the resistors R2 to R4.

With the described monitoring device it is ensured that the functional components of the tail light assembly which are required for traffic safety, i.e., the tail light SL and/or the brake light BR, can be actuated in any situation even when the control unit for the tail light assembly malfunctions. As long as the control unit and/or the control circuit for the tail light assembly operates properly, the emergency path 19 is closed because the semiconductor switch T1 is blocked in the way described above. Accordingly, the respective luminous fields 1 to 3 are actuated via the semiconductor switches T3 to T5 in the described way. The control unit 4 generates at its signal output A1 the alternating current which is then converted by the rectifier 18 to direct current. In the illustrated embodiment the signal which is present at the signal input BR during braking is processed in order to generate alternating current at the signal output A1 of the control unit 4. In the illustrated embodiment, all three luminous fields 1 to 3 can be triggered via the emergency path 19 so that, via this emergency path, the entire tail light assembly of the motor vehicle can be actuated in a way as if the control unit for the tail light assembly had not failed. This provides a high traffic safety.

The program which is stored in the control unit 4 is configured such that at the signal output A1 of the control unit 4 the alternating current signal is generated only when the control unit 4 and/or the control circuit operate properly. When, on the other hand, the control unit and/or the control circuit is defective, a potential is generated at the signal input BR for the brake light upon actuation of the brake of the motor vehicle so that the semiconductor switch T1 receives at the gate a positive potential via the resistor R1 in the current path 20 and thus becomes conductive. At the signal output A1 of the control unit 4 no alternating current is present in this situation but instead a constant voltage or potential. Accordingly, the transistor T2 and the semiconductor switches T3 to T5 remain blocked. This has the result that the luminous fields 1 to 3 are supplied with the required current or the required potential via the current paths 21 to 23 in which the diodes D6 to D8 and the resistors R2 to R4 are positioned.

While specific embodiments of the invention have been shown and described in detail to illustrate the inventive principles, it will be understood that the invention may be embodied otherwise without departing from such principles.

What is claimed is:

1. A monitoring device for a control unit (4) for a signal light of a motor vehicle, wherein the signal light (1-3) comprises one or more tail lights and one or more brake lights, wherein each one of the one or more tail lights and the one or more brake lights has at least one lighting element and at least one signal input, wherein the signal input is connected to the lighting element, respectively, wherein the monitoring device comprises at least one electronic switch (T1) configured to actuate an emergency path (19) to at least one of the one or more tail lights (SL) and the one or more brake lights (BR) when the control unit (4) malfunctions.

2. The monitoring device according to claim 1, wherein the control unit (4) has input terminals (E1 to E3) and signal outputs (A2 to A4), wherein the signal inputs (NSL, BR, SL) of the one or more tail lights (1 to 3) are connected to the input terminals (E1 to E3) of the control unit (4), the monitoring device further comprising electronic elements (T3 to T5), wherein the signal light (1 to 3) is connected via the electronic elements (T3 to T5) to the signal outputs (A2 to A4) of the control unit (4).

3. The monitoring device according to claim 2, wherein the control unit (4) has at least one auxiliary signal output (A1) connected to the emergency path (19).

4. The monitoring device according to claim 3, wherein the control unit (4) supplies a control signal to the auxiliary signal output (A1) and wherein, when the control unit (4) functions properly, the control signal closes the emergency path (19).

5. The monitoring device according to claim 4, wherein the control signal is an alternating current signal.

6. The monitoring device according to claim 5, further comprising a rectifier (18) configured to convert the alternating current signal into a direct current signal.

7. The monitoring device according to claim 6, comprising an auxiliary electronic logic element (T2) arranged in the emergency path (19) downstream of the rectifier (18) and configured to actuate the electronic switch (T1) of the emergency path (19).

8. The monitoring device according to claim 7, wherein the auxiliary electronic element (T2) is a transistor.

9. The monitoring device according to claim 7, wherein the auxiliary electronic element (T2) is positioned in a current path (20) connecting one of the signal inputs (BR) with the electronic switch (T1) and bypassing the control unit (4).

10. The monitoring device according to claim 9, wherein the signal input (BR) connected with the electronic switch (T1) is the signal input (BR) of the brake light (2).

11. The monitoring device according to claim 9, comprising a resistor (R1) arranged in the current path (20) and located downstream of the electronic switching element (T2) but upstream of the electronic switch (T1) of the emergency path (19).

12. The monitoring device according to claim 2, wherein the electronic elements (T3 to T5) are semiconductor switches.

13. The monitoring device according to claim 2, wherein the electronic switch (T1) of the emergency path (19) opens current paths (21 to 23) configured to connect the signal light (1 to 3) with the electronic switch (T1) of the emergency path (19) while bypassing the electronic logic elements (T3 to T5).

14. The monitoring device according to claim 1, wherein at least one of the one or more tail lights and the one or more brake lights is an LED field.
